(19) United States
(12) Patent Application Publication
(10) Pub. No.: US 2023/0012299 A1
(43) Pub. Date: Jan. 12, 2023

(54) TOOL AND METHOD FOR INJECTION MOULDING AN INJECTION-MOULDED PART IN A TOOL

(71) Applicant: BRAUNFORM GMBH, Bahlingen (DE)

(72) Inventors: Georg Franz SEEBACHER, Sexau (DE); Gerd WASMUTH, Gottenheim (DE)

(21) Appl. No.: 17/786,598

(22) PCT Filed: Dec. 1, 2020
(86) PCT No.: PCT/EP2020/084166

§ 371 Date: Jun. 17, 2022

(30) Foreign Application Priority Data
Dec. 19, 2019 (DE) 10 2019 135 127.8

(51) Int. Cl. B29C 45/40; B29C 45/72

(52) U.S. Cl. CPC B29C 45/4005; B29C 45/7207

(57) ABSTRACT

A tool for injection molding plastic parts includes a static overall frame and two structural units for forming a cavity. One of the structural units is arranged displaceably relative to the overall frame and the other structural unit in order to remove an injection-molded part from the cavity. The static overall frame is formed by at least two frame units, in particular a first ejector-side tool element and a second nozzle-side tool element, which are displaceable relative to one another, but in the production mode are displaceable within the scope of the elasticity, which is preferably less than a millimeter.

### BACKGROUND AND SUMMARY OF THE INVENTION

Exemplary embodiments of the present invention relate to a tool and a method for injection molding an injection-molded part in a tool.

Injection-molding tools can be manufactured in several parts. A distinction is usually made between two tool halves, the so-called ejector side and the nozzle side. After injection molding and solidification of the injection-molded part, these two tool halves are usually moved apart. However, the injection-molded part usually remains on the ejector side until it is separated from the ejector side by an ejector or stripper device.

Such devices have already been implemented for many years. For an understanding of individual components of a tool for injection-molding technology, reference is made to the reference book Mink, Walter, Grundzüge der Sprtzgießtechnik (Basic principles of injection-molding technology), 5th edition, 1979, in particular pp. 539 to 542, Zechner & Hünthig Vedag Speyer, to which full reference is made in the context of the present invention.

DE 37 16 796 C2 should be mentioned as further prior art. This does not have a static overall frame, with two frame elements that are displaceable relative to each other, but are displaceable in production mode within the limits of elasticity, preferably less than one millimeter.

DE 10 2008 014 958 A1 is based on a system of an opening tool in which pipes are used to convey the injection-molded parts. This variant essentially corresponds to the initial consideration of multi-part injection-molding tools.

DE 10 2017 114 967 A1 also discloses an opening of an injection-molding machine after molding an injection-molded part for cooling the injection-molded part. Thus, the injection-molded part opens while the injection molding machine is in production mode. The same applies to DE 10 2011 112 971 A1 and U.S. Pat. No. 4,981,634 A, in which the frame units 10 and 12 open towards each other in FIG. 4.

Furthermore, variants are known in the prior art, e.g., DE 20 2010 000 469 U1, in which mold inserts of an injection-molding tool are transported to several production stations in a closed state. However, these mold inserts are not comparable with an injection-molding tool, but are merely part of such a tool. The same applies to DE 10 2005 003 074 B4, which uses a robot arm for station-by-station transfer.

Based on the aforementioned prior art, a tool is to be created with which higher production efficiency can be achieved. The key figure for this is the so-called cycle time, which is thus to be reduced.

A tool according to the invention for the injection molding of plastic parts has a static overall frame and two structural units for forming a cavity, wherein at least one of the structural units is arranged to be displaceable relative to the overall frame and the other structural unit for ejecting an injection-molded part from the cavity.

The overall static frame can preferably consist of several tool elements. Typically, there is a first ejector-side tool element and a second nozzle-side tool element that are movable relative to each other.

The tool preferably has at least two operating modes or, in other words, it can be operated in at least two operating modes. A first operating mode is the production mode. In this mode, the injection-molded parts are formed in the cavity, cooled and removed from the cavity, in particular ejected. A further operating mode can be, for example, the maintenance mode, in which the tool elements are moved apart so that maintenance and/or cleaning of the surfaces of the tool elements that are aligned with each other in the production mode can take place.

To minimize wear, or due to settling movements in the machine, a minimum tool opening can occur or be provided. This depends on the accuracy of the machine clamping unit. However, this opening should be less than five millimeters. This opening is closed when the clamping force is built up. Moreover, the tool elements of the overall frame are displaceable in production mode within the limits of elasticity, preferably less than one millimeter. Accordingly, the terms “static overall frame” and “closed tool” are to be interpreted in the context of the present invention, since the tool halves, as frame parts forming the overall frame, move relative to each other to a very small extent during the injection molding cycle. Obviously, reliable ejection of the injection-molded parts cannot be achieved with this small spacing of the tool elements. Rather, the gap created by the opening is preferably smaller than the smallest dimension of a formed injection-molded part.

This means that there is no tool opening of the machine required for ejection of the injection-molded part. The opening movements of conventional machine/tool half combinations for ejection of injection-molded parts are comparatively slow due to the high mass and distance involved.

According to the invention, the tool has a drain for removing formed injection-molded parts from the area of the structural units in the closed state of the tool, wherein closed state also includes variants of a small opening.

The terms molding, injection-molded part, molded part, and plastic part are used synonymously in the context of the present invention. The tool according to the invention is used for the injection molding of injection-molded parts, in particular plastic parts.

Each of the two tool elements may have a mold insert to form the cavity, often called a mold cavity or mold.

In the prior art, the aforementioned tool elements are typically moved together or closed during injection molding and opened for emptying. However, in the context of the present invention, the tool elements form part of the overall static frame and remain moved together both during mold part formation and during emptying, taking into account a displaceability within the scope of elasticity during the molding process of less than 5 mm, especially less than 1 mm.

The aforementioned structural unit may include the mold insert and further molding parts such as mold cores and mold pins, and may also include an ejector package. In this context, the structural unit can optionally, as the first structural unit of the tool element, be detachably arranged on a second structural unit of the associated tool element in such a way that the first structural unit can be inserted and/or fitted into the second structural unit at least in some areas in a predetermined stacking direction and is mounted in the stacking direction. The second structural unit can comprise an ejector pressure plate and/or a mold insert retaining plate.

In this way, the entirety of the first structural unit, e.g., the mold insert and the ejector package, can be separated from the rest of the tool element and replaced. By locking the first structural unit to the second structural unit, the first structural unit is secured against unpredictable loosening. At the same time, only a few steps are required to completely release the structural unit. The first structural unit can be connected to the second structural unit by a locking mechanism.

The tool elements can be designed as two halves of the tool, but in addition to the tool halves, other components or structural units of the tool can also be provided. One half of the tool is the nozzle side and consequently includes the injection molding nozzle. This is referred to below as the nozzle side. The second tool half has an ejector package for separating the injection-molded part from the mold insert. It is therefore referred to hereinafter as the ejector side. In the aforementioned tool element, an ejector device for ejecting finished injection-molded plastic parts is combined with the mold insert.

The tool element can also have a tool base plate, which is part of the overall static frame. Instead of the ejector package, nozzles, e.g., for compressed air, can also perform the ejector function.

The tool may further comprise a second nozzle-side tool element having a structural unit comprising at least one mold insert. Furthermore, the tool element has a tool base plate. The tool base plate can also be formed together with a frame plate closed at the rear.

The ejector-side structural unit and the nozzle-side structural unit together form the cavity for molding an injection-molded part. The respective structural units can preferably have one or more mold inserts, casting cores and/or pins for forming the cavity.

The displaceable structural unit is such that the cavity for forming the injection-molded part can be opened and closed with the tool otherwise closed. The displaceable structural unit allows a stroke movement of one mold insert relative to the other mold insert. During the stroke movement, the mold insert can lower into the frame, which is formed by or connected to the tool base plate. The stroke thus simultaneously describes a relative movement between the mold insert and the frame. Due to the short stroke distance, a faster cycle time is achieved. The same applies to the reduction in stroke mass because the mass of the moving components is reduced. This also results in faster cycle times.

Further according to the invention is a tool for the injection molding of several plastic parts, wherein the tool has the aforementioned overall static frame and has two structural units for forming a cavity, wherein next to, preferably below a structural unit and/or one or a group of cavities, there is a discharge of the ejected injection-molded parts or plastic parts produced, and wherein a transport device necessary for the discharge is associated with the tool. The integration of the transport device in the tool enables a compact design and allows the drop height of the manufactured plastic parts to be reduced.

The opening of the structural units necessary for removal can preferably be minimally larger than the smallest spatial extension of a formed injection-molded part, e.g., thickness or width of the formed plastic parts, preferably 0-100% thereof, or not 0-100% larger than the width of the transport device intended for removal.

Two frame units may form the overall static frame, wherein the overall static frame comprises at least two frame units, in particular a first ejector-side tool element and a second nozzle-side tool element, which are displaceable relative to each other, but are displaceable within elasticity, preferably less than one millimeter, in the production mode.

Also preferably, the two frame parts are displaceable in the overall frame due to settling movements and/or the wear protection, preferably less than five millimeters.

This ensures only a small opening stroke between the mold inserts within the tool when the tool is closed.

A closed tool is understood to be an essentially closed outer contour of the tool. Gap formation by moving the tool elements or tool halves apart is not mandatory. The tool base plates of both tool elements do not move towards or away from each other during the entire manufacturing process for providing the injection-molded part, or only within the limits of elasticity. The tool base plates are also understood as clamping plates. They are engaged by a machine to press the two tool halves together. The tool base plate and plates connected thereto transmit the forces to a mold insert plate. They can particularly preferably be regarded as part of the overall frame.

As a result of the mold filling, a mold buoyancy force is created by the pressure effect, which in turn has an opening effect for the mold. If the mold opens at the parting surface during the pressure effect, undesirable burr formation on the injection-molded part can occur, among other things. The tool is therefore subjected to the clamping force during injection molding to prevent this. During ejection of the injection-molded part, this force is reduced. Once the tool has been subjected to the closing force, the difference between the clamping force and the buoyancy force results in the residual sealing force. The softer the tool, the more the tool springs back as a result of the pressure reduction. Burr formation or overmolding thus only occurs at higher buoyancy forces.

The sealing force for sealing the cavity must act on the directly adjacent mold parting line. The spotting area must be large enough to ensure that the resulting surface pressure does not exceed the permissible limit. The larger the spotting area, the larger the pressurized tool cross-section. Therefore, more material will be deformed to achieve the desired sealing effect. As with a spring, the cross-sectional area of the latter increases the force required to achieve the desired deformation. The stiffness increases with a higher cross-section and thus also the clamping force requirement. Since in the tool mentioned, on the ejector side, the force flow contributing to the interlocking lies only on shaping tool components behind or in front in the stacking direction, the requirement to generate the necessary sealing force is lower. This is because the pressurized tool cross-sectional area is smaller than in conventional tools. The tool is therefore softer. Therefore, as described above, overmolding only takes place at higher uplift forces. This provides additional process reliability.

At least the optional ejector package and the ejector-side mold insert are components of the tool according to the invention. Optionally, one of these two components can be arranged to be movable relative to the other component in such a way that, when the tool is closed, the component can be moved relative to the respective other component so that, due to the difference in stroke between the ejector package and the mold insert, the injection-molded part can be lifted from the surface of the ejector-side mold insert when the cavity is open.

At least the optional ejector package and the nozzle-side mold insert as components of the tool can also optionally be arranged relative to one another in such a way that, when the tool is closed, one component is also arranged to be movable relative to the respective other component.

Particularly preferred for the above variants is that the mold insert on the nozzle side is stationary and the mold insert on the ejector side and the ejector package are each arranged to be movable relative to this mold insert and with a different stroke relative to each other. However, both units can also be arranged to move relative to the overall static frame.

The tool preferably has a discharge line for removing formed injection-molded parts from the area of the mold inserts or the cavity when the tool is closed, so that a continuous sequence of subsequent runs is ensured.

The tool according to the invention makes it possible to reduce the stroke mass, which means that less force has to be applied. Furthermore, the cycle times during injection molding are considerably reduced.

Other advantages include energy savings due to the reduction in moving mass and the possibility of using drives with less power, which leads to a price reduction in manufacturing.

In addition, miniaturization can be achieved, since less expensive and more compact drives can be used to move the components. The force flow can also be tuned more precisely.

Further advantageous designs of the invention are explained below.

The displaceability of the structural unit or structural units is advantageously ensured in a production mode of the tool in which the ejection of the injection-molded part from the cavity takes place.

In this case, the relative displacement of the structural unit to open the cavity and eject the injection-molded part is performed by a movement or it is driven by a drive.

Preferably, a retaining element can ensure that the injection-molded part is retained on one of the structural units during displacement of the at least one structural unit. For example, a retaining element can be individual or multiple nozzle-side ejector rods.

The ejector-side tool element, in particular the first structural unit, can have an ejector unit, in particular an ejector pack, ejector rods, an ejector retaining plate, and/or an ejector pressure plate, which lifts the injection-molded part off the structural unit.

The aforementioned retaining element can release the injection-molded part for demolding before or during the movement of the ejector unit.

As previously explained, a respective structural unit may have at least one mold insert, with the nozzle-side mold insert or structural unit and the ejector-side mold insert or structural unit forming the cavity. The respective structural unit may also have any other shaping parts of an injection-molding tool, such as cores, pins, or the like.

The structural unit may include at least one ejector or stripper unit.

The components of the overall frame can have a tool base plate.

The displaceable structural unit comprises a plurality of components, wherein at least one of the components comprising the ejector package and the ejector-side mold insert is arranged to be displaceable in the closed state of the tool (relative to the other component in each case) such that the injection-molded part can be lifted from the surface of the ejector-side mold insert when the cavity is open but when the overall frame is static, i.e., in production mode.

At least the ejector package and the nozzle-side mold insert can be arranged to move relative to the other component when the tool is closed.

The discharge via the receiving chamber for removing the formed injection-molded parts can advantageously be designed as a drop chute.

Preferably, the tool has at least one row of the aforementioned mold inserts, with at least one drop chute extending parallel adjacent to the row of the aforementioned mold inserts. Alternatively, a chute or conveyor belt may be provided for transporting the injection-molded parts via the receiving space directly out of the tool or out of or into the drop chute.

In addition, the tool can have a plurality of linearly movable transport carriages for transporting injection-molded parts, with each transport carriage being particularly preferably designed to accommodate one injection-molded part. The transport carriage can be arranged in such a way, preferably below the cavity or the mold inserts, that the drop height of the injection-molded part minus the intrinsic volume of the injection-molded part is less than 50 mm, preferably less than 20 mm. This can significantly reduce the drop times and thus the cycle time.

It is also conceivable that several injection-molded parts, but not all, fall from a corresponding number of cavities in or on a transport means. This may allow the cavities to be brought closer together. The tool can thus be made more compact. A reduction in cycle time compared to conventional injection molding nevertheless exists.

The movable structural unit can consist of a mold unit and an ejector unit, with the mold unit being movable to a greater extent than the ejector unit. The ejector unit thus retracts to a lesser extent than the mold unit or mold insert, so that the ejector rods of the ejector unit protrude from the surface of the mold unit in the open state, thereby lifting the injection-molded part from the surface.

Advantageously, the ejector unit and the mold unit are moved by a single drive, so that the movement of both units is preferably synchronized but with different strokes. The terms mold unit and mold insert as well as ejector unit and ejector package are used synonymously in the context of the present application.

The cavity can be released in a concerted stroke movement of the ejector-side mold insert with the ejector package, wherein the stroke of the mold insert and the stroke of the ejector package are of different sizes. This allows several components to be moved simultaneously, thereby reducing cycle times. In addition, an ejector accelerator can be provided.

After the injection-molded parts have been discharged in step Z, they are preferably transported away to a drop chute by a movable, in particular linearly movable, transport carriage, with the transport away taking place at the same time as the method steps X and Y of a subsequent pass are carried out, and the transport away is completed at the end of step Y of the subsequent pass.

A drop chute does not necessarily have to be formed perpendicularly in the tool, but can also be designed as a chute with an inclined track.

The frame unit can additionally be temperature-controlled by introducing a temperature-control medium into corresponding channels in the frame unit to support and/or replace a temperature-control system present in the mold insert, in particular if there is no installation space for a temperature-control system in the mold insert.

The tool can also advantageously have viewing windows and/or light barriers to enable inspection of the area between the two mold inserts. In this way, sources of error can be detected or optically determined.

The drop chute can define a drop direction and wherein the transport carriage is designed to travel at an angle, in particular perpendicular to the drop direction.

Each of the transport carriages or a carriage arrangement consisting of several transport carriages can have a rack and pinion extension which is arranged in relation to a drive gearwheel in such a way that, when the drive gearwheel is moved, transport carriages are arranged so that they can move linearly in opposite directions to one another.

The gearbox comprising the rack and pinion extension and the drive gear can advantageously be additionally protected from contamination by a partial housing. Instead of the rack and pinion extension, a gripper can also be provided, for example. The transport carriage can be driven by an electric motor, hydraulically or pneumatically.

Such drives can, also advantageously, be used to drive a locking mechanism via which a space for the stroke is released. A spindle drive is also advantageous here.

In particular, the drive of the transport slides can be designed independently of the drive to the tool opening.

The tool, in particular the transport carriage, can have a nozzle for transmitting a pressure surge, preferably in the design as a compressed-air nozzle.

The tool may have a channel for supplying a medium for generating a pressure surge, in particular compressed air, to the nozzle, the channel being arranged in an ejector-side mold insert retaining plate.

The nozzle-side tool element can have at least one nozzle-side ejector for holding the injection-molded part when the cavity is open on the surface of the ejector-side mold insert, wherein an ejector rod of the ejector is mounted so as to be linearly movable relative to the nozzle-side mold insert, preferably in such a way that the ejector rod can be at least partially extended from the surface of the nozzle-side mold insert.

The tool, in particular the ejector-side tool element, can have a locking system or locking mechanism, the unlocking of which enables a linear movement, in particular a stroke movement, of the ejector-side mold insert and ejector package relative to the overall frame, in particular the tool base plate, if this is part of the overall frame.

The locking system or locking mechanism can advantageously be designed as a helical toothing or a gap toothing.

The locking system or locking mechanism can generate a force build-up on the ejector-side mold insert during the injection molding process when locked, and allow the cavity to open when unlocked.

In a particularly preferred embodiment variant, the actuation of the locking mechanism can be controlled. For this purpose, for example, a guide cam of the control strip or a mechanical two-stage system can be designed.

In the locked state, the tool can also be operated in conventional mode, by a displacement of at least one complete tool half, typically the ejector-side tool half, relative to the second tool half.

Preferably, the locking mechanism can transmit or generate a closing force when locked and allow the cavity to open when unlocked, forming an opening gap to release the injection-molded part.

The locking mechanism can in particular comprise an interlocking, in particular in the form of toothing, between a support plate, which is mounted so as to be displaceable in the direction perpendicular to its projections, in particular teeth, and a base plate, by means of which pressure can be applied to the mold insert. Instead of the toothing, the interlocking can also be achieved by means of projections and corresponding recesses.

The closing force can preferably be machine-generated.

The tool can build up a restoring force within the scope of its elasticity when it is locked.

In a particularly preferred embodiment variant of the invention, the tool is constructed in such a way that the stroke movement of the ejector rods is less than the stroke movement of the mold insert.

The displaceability of at least one of the mold inserts and the ejector package can be effected by a guided stroke movement of at least these components and/or of one or more plates acting on these components, wherein the tool has a link guide for guiding the stroke movement of the respective mold insert, the ejector package and/or the aforementioned plate or plates.

The link guide can advantageously be part of the overall frame or be connected to it and, in particular, be connected to the tool base plate or the frame part.

The ejector and/or stripper unit, in particular the ejector package, can preferably be arranged between a mold insert retaining plate and a mold insert pressure plate.

The mold insert can advantageously be guided and preferably centered in a frame plate.

The movement of the aforementioned components can be synchronized up to a certain point so that the injection-molded parts fall at a defined point in time. The synchronous running can be achieved by arrangement and design of guide slots of the link guide.

The link guide can have two guide slots in which projections of the respective mold insert, ejector package and/or plate or plates engage, with the guide slots having a different pitch at least in some areas.

The link guide can be connected directly or indirectly to the tool base plate.

To generate synchronous operation, the guide slots can extend partially parallel, in particular with the same pitch, and in a further course with different pitches to each other in such a way that the stroke movement of the ejector rods is less than the stroke movement of the mold insert.

In a further advantageous embodiment variant of a tool according to the invention, the ejector-side tool element may have a channel for applying a pressure surge in a mold insert, in particular a compressed-air channel, for ejecting the injection-molded parts alternatively or in addition to an ejector package. Therefore, in the context of the present invention, an ejector-side tool element is understood to be a tool element that has an ejector device. This does not necessarily have to be a mechanical ejector device with ejector rods, but it can also be a feed device for compressed air.

Further according to the invention is a method for injection molding an injection-molded part in a tool, in particular in a tool according to the invention, wherein the tool has a static overall frame and two structural units for forming a cavity, with one of the structural units being arranged displaceably relative to the overall frame and the other structural unit for ejecting an injection-molded part from the cavity, wherein the method comprises a production mode having at least the process steps of:
X injection molding of an injection-molded part with closed cavity;
Y releasing the cavity by executing a stroke movement of one of the structural units, in particular of the structural unit with the ejector-side mold insert relative to the structural unit with the nozzle-side mold insert, forming an opening gap;
Z discharging the injection-molded part from an opening gap between the structural units,
   and wherein the tool remains closed during the execution of the production mode.

In a preferred embodiment variant of the method, the release of the cavity takes place in a concerted stroke movement of the ejector-side mold unit with the ejector unit, wherein the stroke of the mold unit and the stroke of the ejector unit are of different sizes.

After the injection-molded parts have been discharged in step Z, they can be transported away to a chute by a movable, in particular linearly movable, transport carriage, wherein the transport away takes place at the same time as the process steps X and Y of a subsequent pass are carried out, and wherein the transport away is completed when step Y of the subsequent pass is finished.

Optionally, at least one of the tool elements can also have a movably or displaceably mounted mold insert retaining plate for mounting at least one, but in particular a plurality of mold inserts. This can be provided with channels for supplying a temperature-control medium to the mold insert or mold inserts. The mold inserts can also have corresponding channels into which the temperature-control medium can be transferred from the channels of the mold insert retaining plate.

In a preferred embodiment variant of the invention, and particularly advantageously in the context of reducing cycle times, the removal of a first batch of injection-molded parts from the mold can take place simultaneously, i.e., in parallel, with the molding process and/or cooling of a second batch of injection-molded parts. The molding process preferably involves filling the cavity and post-mold pressing with an increase in the clamping force. The second batch can also be transported away after being molded, while a third batch is molded and/or cooled at the same time. By superimposing parts of two cycles, an additional reduction in cycle time can be achieved.

The frame units, in particular the tool elements, preferably comprise the tool base plate. The tool itself can preferably be designed as a sequence of several plates stacked one on top of the other in a sandwich-like manner, including the mold insert plate and the injection-molded parts inserted therein. The frame units are part of this tool. The stacking direction of the plates corresponds to the surface normal of the contact surfaces of the two frame units. In this stacking direction, the frame units are displaceable in the production mode within the limits of elasticity, preferably less than one millimeter.

The tool according to the invention is designed in particular as a production means with molding inserts or mold inserts, which are sandwiched in a support structure as an overall frame and further plates. This support structure serves to support a mold insert plate in which one, but preferably a plurality of molding inserts or mold inserts can be inserted or supported. In addition to the mold insert plate, the tool half also comprises at least one tool base plate as part of the frame unit, on which pressure is applied to the tool, e.g., by a lever arm or the like.

In production mode, the mold inserts remain in the frame unit, or in the mold insert plate. Thus, each of the two frame units supports a molding injection-molding insert which remains in the frame unit during production mode. However, a certain play relative to the mold insert plate of less than 1/10 millimeter is permitted within the framework of a floating bearing arrangement and is also understood as a fixed arrangement within the meaning of the present invention.

Separate removal of the mold insert for its cooling during production of the injection-molded part, i.e., in production mode, is not provided.

Further, the tool of the present invention is designed to produce an injection-molded part in a sprueless concept, i.e., without producing a sprue pin, which must be discharged separately.

### BRIEF DESCRIPTION OF THE DRAWING FIGURES

The invention is explained in detail below with reference to several exemplary embodiments and with the aid of the following figures, wherein:

FIG. 1 shows a side view of a first variant of a tool according to the invention in the closed state;

FIG. 2 shows a sectional view through the tool according to the invention in the injection position in section A-A;

FIG. 3 shows a sectional view through the tool according to the invention in the injection position in section C-C, perpendicular to the sectional view of FIG. 2;

FIG. 4 shows an enlargement of the sectional view of FIG. 3;

FIG. 5 shows greater magnification of the sectional view of FIG. 4;

FIG. 6 shows an enlargement of a partial section of the section of FIG. 2 on two superimposed section planes;

FIG. 7 shows a top view of the end face of the first ejector-side tool element of the tool according to the invention in the injection position;

FIG. 8 shows a top view of the end face of the second nozzle-side tool element of the tool according to the invention in the injection position;

FIG. 9 shows a sectional view A-A through the tool perpendicular to the opening plane at process step A;

FIG. 10 shows a view of the end face of the nozzle-side tool element during process step A;

FIG. 11 shows a detailed view of the area of the injection-molding cavity of FIG. 10 during process step A;

FIG. 12 shows a detailed view of a transport carriage at process step A;

FIG. 13 shows a sectional view B-B perpendicular to sectional view A-A and to the opening plane at the level of the ejector package at process step A;

FIG. 14 shows a detailed view of the area of the injection-molding cavity of FIG. 13 during process step A;

FIG. 15 shows a sectional view A-A through the tool perpendicular to the opening plane at process step B;

FIG. 16 shows a detailed view of the area of the injection-molding cavity of FIG. 15 at process step B;

FIG. 17 shows a view of the end face of the nozzle-side tool element during process step B;

FIG. 18 shows a detailed view of a link guide 14 in process step B;

FIG. 19 shows a detailed view of a transport carriage at process step B;

FIG. 20 shows a sectional view A-A through the tool perpendicular to the opening plane at process step C;

FIG. 21 shows a detailed view of the area of the injection-molding cavity of FIG. 20 at process step C;

FIG. 22 shows a view of the end face of the nozzle-side tool element at process step C;

FIG. 23 shows a detailed view of a link guide 14 in process step C;

FIG. 24 shows a sectional view B-B-perpendicular to the sectional view A-A and to the opening plane at the level of the ejector package at process step C;

FIG. 25 shows a detailed view of the area of the injection-molding cavity of FIG. 24 at process step C;

FIG. 26 shows a sectional view A-A through the tool perpendicular to the opening plane at process step D;

FIG. 27 shows a detailed view of the area of the injection-molding cavity of FIG. 26 at process step D;

FIG. 28 shows a view of the end face of the nozzle-side tool element at process step D;

FIG. 29 shows a detailed view of a link guide 14 in process step D;

FIG. 30 shows a sectional view B-B perpendicular to sectional view A-A and to the opening plane at the level of the ejector package at process step D;

FIG. 31 shows a detailed view of the area of the injection-molding cavity of FIG. 30 at process step D;

FIG. 32 shows a sectional view A-A through the tool perpendicular to the opening plane at process step E;

FIG. 33 shows a detailed view of the area of the injection molding cavity of FIG. 26 at process step E;

FIG. 34 shows a view of the end face of the nozzle-side tool element during process step E;

FIG. 35 shows a sectional view A-A of a modified second variant of a tool according to the invention;

FIG. 36 shows a sectional view B-B of the second variant;

FIG. 37 shows an enlargement of FIG. 36;

FIG. 38 shows a detail view of an ejection device of FIG. 37;

FIG. 39 shows an enlargement of FIG. 35; and

FIG. 40 shows a detailed view of a link guide from FIG. 35.

### DETAILED DESCRIPTION

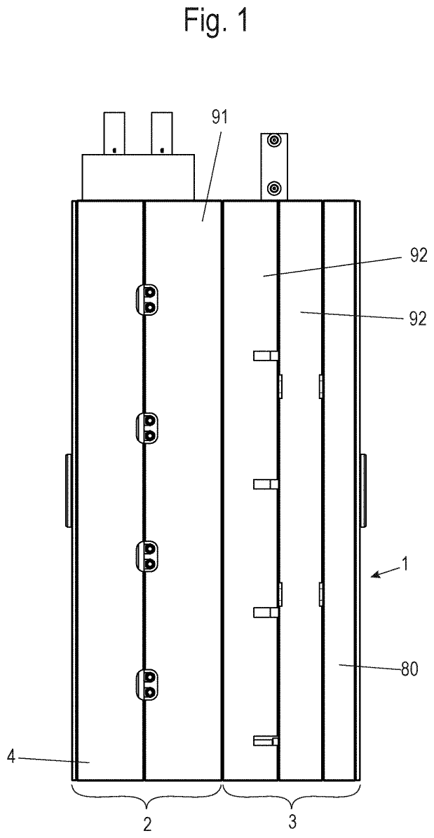

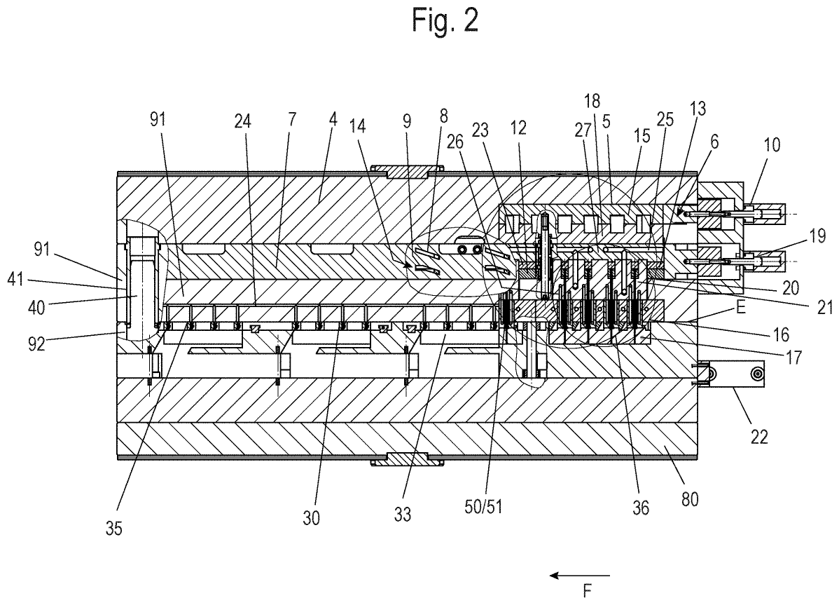

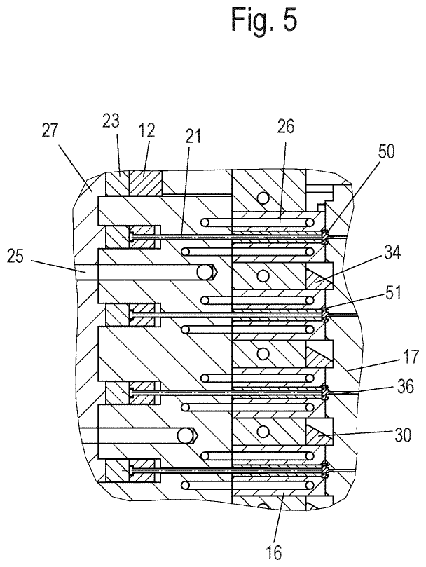

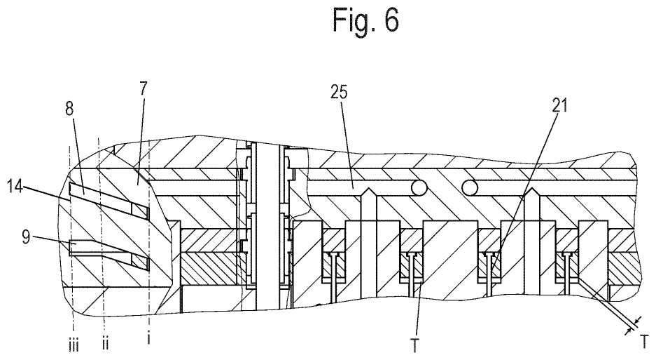

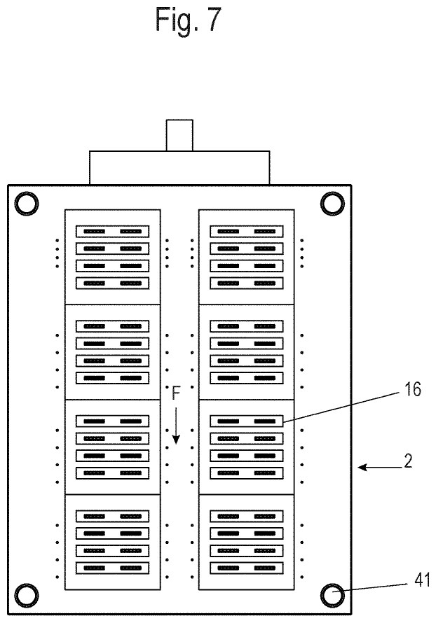

FIGS. 1-8 show a multi-part injection-molding tool 1 according to the invention comprising two tool halves 2, 3, namely an ejector side and a nozzle side. The tool halves 2 and 3 comprise, among other things, a plurality of plates which are arranged one above the other in a stacking direction A. The structure of both tool halves is explained in more detail in FIGS. 2-8. These figures are representations of one and the same tool 1 in a first process step A.

FIGS. 2 and 4 are each a sectional view perpendicular to the stacking direction A and to the plate plane of at least one tool base plate 4. The tool base plate 4 on the ejector side and also the tool base plate on the nozzle side each have a receptacle for positioning a pressurizing machine part, e.g., a pressure pin. The sectional view was selected for complete representation at different depths, i.e., at different heights of the sectional planes.

FIG. 2 is a sectional plane at the level of an ejector rod 21. The ejector-side tool half comprises a tool base plate 4, which is provided with a recess 5 for accommodating an element of a locking mechanism 6. The tool base plate 4 has a plate plane and defines a stacking direction A perpendicular to this plate plane.

In the stacking direction A towards the second nozzle-side tool half, two bearing strips 7 are arranged on the tool base plate 4 or at least one frame plate 91 is arranged, which rests against the tool base plate 4 and is immovably connected to it. A free space 13 is arranged between the bearing strips. Similarly, a recess can be arranged in the frame plate 91. The free space 13 or the recess serves to accommodate a mold insert retaining plate 11 and/or an ejector package retaining plate 12.

The frame plate 91 or bearing strip has a link guide 14. This link guide 14 comprises at least two guide slots 8 and 9 extending obliquely in the frame plate 91 or bearing strip, which differ from one another in part in their pitch. In FIG. 2, two guide slots 8 arranged next to each other can be seen in a sectional view K with a continuously and in particular constantly rising course and around two guide slots 9 also arranged next to each other, in the course of which the pitch changes or flattens. Two different guide slots 8 and 9 are preferably arranged one above the other, i.e., perpendicular to the plate plane. The guide slots do not necessarily have to pass through the frame plate 91 or the bearing strips, but can also be understood merely as elongated recesses which are worked into the material of the frame plate 91 or bearing strip in the manner of grooves.

The mold insert retaining plate 11 is traversed with channels 24 for supplying a medium. These channels 24 allow the introduction of compressed air, for example, to assist the ejection of an injection-molded part 50 or, alternatively, of a temperature-control medium to control the temperature of the mold insert.

The mold insert retaining plate 11 also has one or more mold inserts 16. These mold inserts are mostly made of metal and/or ceramic. They are movably attached to the tool half 2 by the mold insert retaining plate 11. The mold insert or the retaining plate are preferably guided by a frame plate 91 or frame insert 42 and centered. The respective mold insert has an end face which, together with a corresponding mold insert 17 of the second tool half, i.e., the nozzle side, defines a cavity 51 for the injection-molded part 50.

In FIG. 2, the locking mechanism 6 comprises two toothed racks 15 and 18, which can be displaced relative to one another parallel to their longitudinal extension, wherein the end faces of the teeth of the first toothed rack 15 are in contact with the end faces of the teeth of the second toothed rack 18 in the locked state. Between the teeth, the racks 15 and 18 have intermediate spaces with bottom surfaces.

Furthermore, the locking mechanism has at least one actuating element 10, e.g., a lever, motor cylinder, or the like, which can protrude from the contour of the tool 1 at the edge. By moving the actuating element 10, the actuating element is moved by a distance 101. In the process, the toothed rack 15 covers a travel distance 94 in a direction parallel to the opening plane E of the tool 1.

In the unlocked state, the end surfaces of the teeth of the first toothed rack 15 are in contact with the bottom surfaces of the spaces between the teeth of the second toothed rack 18. In other words, the toothed racks are interlocked.

The difference in height between the teeth of the racks and their bottom surfaces permits a stroke movement of the mold insert retaining plate 11 and the ejector package retaining plate 12 in the stacking direction S in the unlocked state. The ejector package retaining plate 12 has an ejector package 20. This typically comprises at least one or more ejector rods 21, which are displaceably mounted relative to the mold insert, for ejecting an injection-molded part from the mold insert. An ejector package 20 also preferably comprises an ejector retaining plate 22 and an ejector pressure plate 23. The ejector retaining plate 22 is used to hold and position the ejector rods 21. The ejector rods 21 have an end formation or reinforcement against which the ejector retaining plate 12 is initially pulled. The retaining plate presses in the process. The pressure plate presses when the ejector package is moved forward during a stroke H.

While the mold inserts perform a stroke or full stroke in relation to each other, the ejector package only performs a partial stroke T.

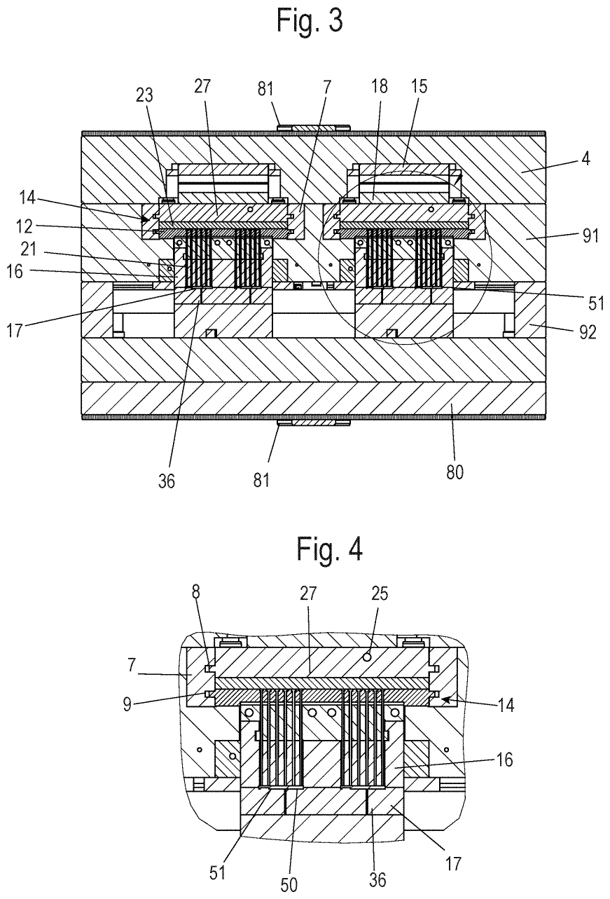

The mold inserts 16 are held by the mold insert retaining plate 11. They may each have a mold core in the center. This can be made of a better heat-conducting material than the remaining material of the mold insert, e.g., copper or the like. This can be seen particularly well in FIG. 3 and FIG. 4.

For holding the mold inserts 16, the mold insert retaining plate 11 has recesses for receiving the mold inserts 16. A conventional screw connection and pin centering is also conceivable.

The mold insert retaining plate 11 rests in some areas on a mold insert pressure plate 27. This is movable linearly and perpendicularly to the stroke movement and presses on the mold inserts 16 and/or the mold insert retaining plate 11 during a stroke movement in stacking direction S. The mold insert pressure plate 27 has a projection that engages in the guide slot 8 of the link guide 14. This converts the linear motion of the mold insert pressure plate 27 into the stroke motion. To move the mold insert pressure plate, it has an actuating element 19. The mold insert pressure plate 27 also has channels 25, which open into channels 26, which are arranged in the mold insert 16 and allow a temperature-control medium to be introduced into the mold insert 16. On the edge side, the mold insert pressure plate 27 and/or the mold insert retaining plate 11 can be provided with a gas or temperature-control medium connection to allow the aforementioned media to be introduced on the edge side. As a result of a linear movement at the actuating element 19, this can be moved around parallel to the opening plane in a region 101 around a travel distance.

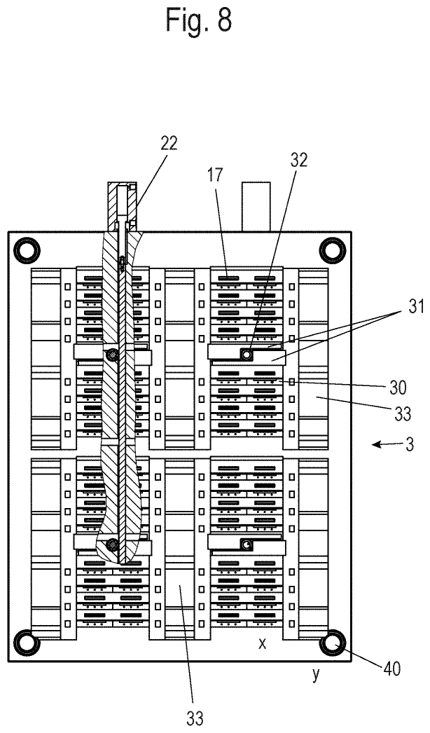

FIG. 8 shows an opened end face of the second tool half 3, i.e., the nozzle side. Furthermore, the tool half 3 on the nozzle side has a tool base plate 80 and two frame plates 92 arranged thereon. As is typical for a frame, the frame plates have a central recess for mounting the mold inserts.

The relative movement of the nozzle-side tool half 3 with respect to the ejector-side tool half 2 can be guided via edge-side guide columns 40 when opening the tool 1, as can also be seen in FIG. 2. These engage in corresponding guide bushes 41 of the ejector-side tool half 2. If the tool 1 should be opened, e.g., for maintenance reasons, this movement is consequently guided. However, regular opening of both tool halves 2 and 3 for ejecting the injection-molded parts 50 is no longer necessary within the scope of the present invention.

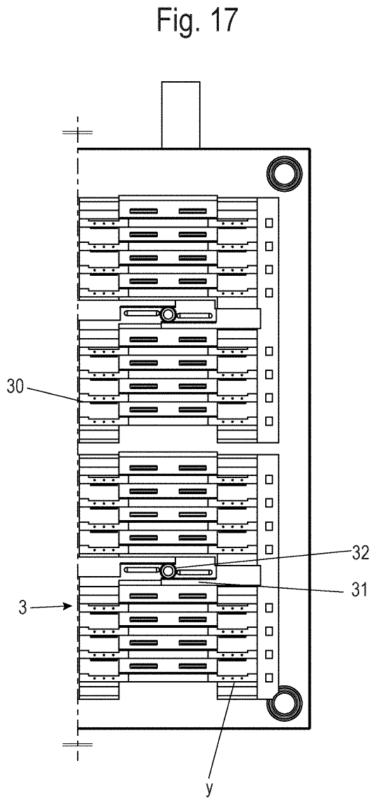

As shown in FIGS. 17 and 29, the injection-molded parts 50 can be transported away via transport carriages 30, which are arranged in the direction of fall T below the nozzle-side mold insert 16 on the nozzle-side tool half 3. The falling direction T is arranged perpendicular to the stacking direction S. The carriages are mounted so as to be linearly movable, preferably movable in a direction perpendicular to the direction of fall T, relative to the mold insert 16 on the nozzle side by means of a drive. Several carriages 30 are connected to one another to form a unit which has a rack and pinion extension 31, which engages in a drive gearwheel 32 arranged centrally below the mold insert 16 or is intermeshed with the latter. In this case, a rack and pinion extension 31 of a first unit of carriages 30a is intermeshed with the drive gearwheel 32 above the latter, and a rack and pinion extension 31 of a second unit of carriages 30 is intermeshed with the drive gearwheel 32 below the latter. The first and second carriages 30′ and 30″ are thereby adjacent to each other in a receiving position X below the mold insert 16. When the gearwheel 32 rotates, a first carriage 30′ is moved to the right and a second carriage 30″ is simultaneously moved to the left to an ejection position Y. In the ejection position, the injection-molded parts 50 are each transferred into a drop chute 33, by which is also understood a vertical duct but also a chute or slope, which has at least the width of the injection-molded parts and which extends in the direction of drop F. These drop chutes 33 are arranged to the left and right of the mold insert 16 or an arrangement of several mold inserts 16 arranged one above the other and serve to transport the injection-molded parts out of the tool when it is otherwise closed.

In particular, the drop chutes 33 are arranged on the nozzle-side tool half 2. Furthermore, the nozzle-side mold insert 17 has a lead-through opening 29, for leading through a pressure-loaded linear-movable ejector rod 36. The pressure load can be generated, for example, by a spring, so that the ejector rod 36 is spring-mounted.

The transport carriage 30 has a receiving space 34 that is open at least at the top for receiving the injection-molded part.

Transferring the injection-molded parts from the carriage 30 into the chute in ejection position Y, the transport carriage 30 is tilted in ejection position Y so that the injection-molded part can slide into the chute due to its own weight.

The emptying of the carriage can be supported by a pressure surge. For this purpose, the carriage 30 has a nozzle opening 35. This can be arranged in the bottom of the carriage 30, for example. In the ejection position Y, the nozzle opening 35 corresponds with the channel 24 in such a way that a pressure surge imparted by the channel 24, for example by compressed air, is transmitted to the injection-molded part via the nozzle opening 35. Alternatively, a tilting movement of the carriage for emptying is also conceivable.

In the following, the movement sequence of individual components within the tool 1 will now be explained in more detail. The tool operates in a process cycle in which the tool base plates 4, 80 and the frame parts 91, 92 are not moved and form an outwardly closed tool. Reference sign F refers to a falling direction. It is understood that after the sequence of process steps the cycle starts again.

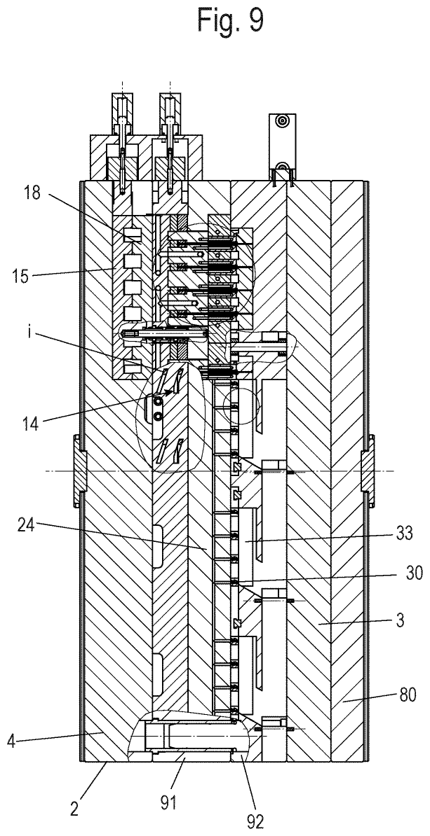

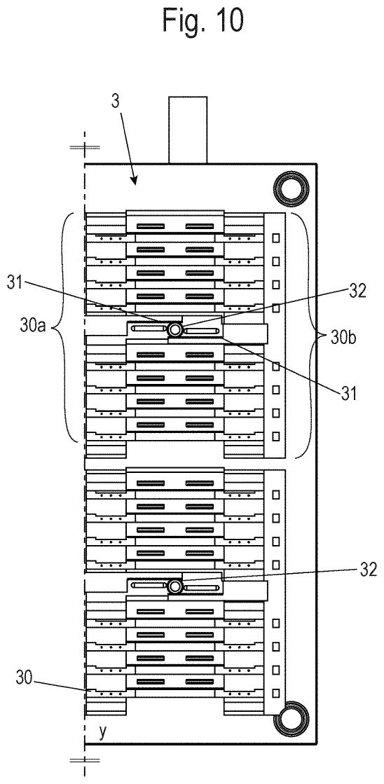

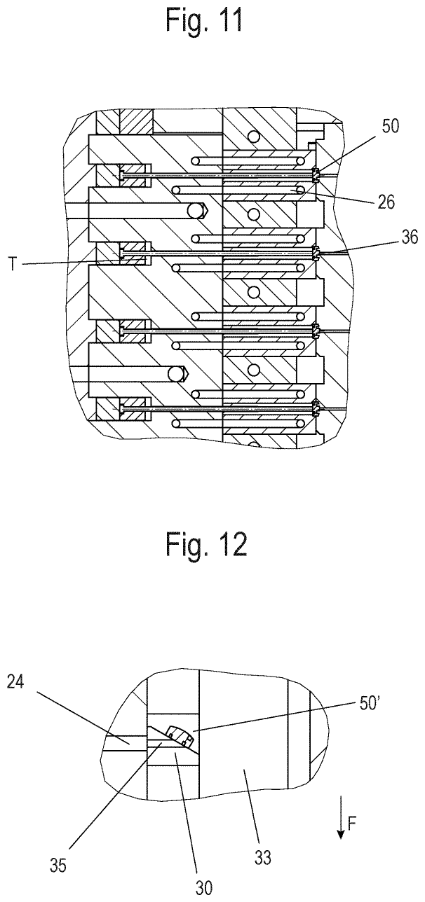

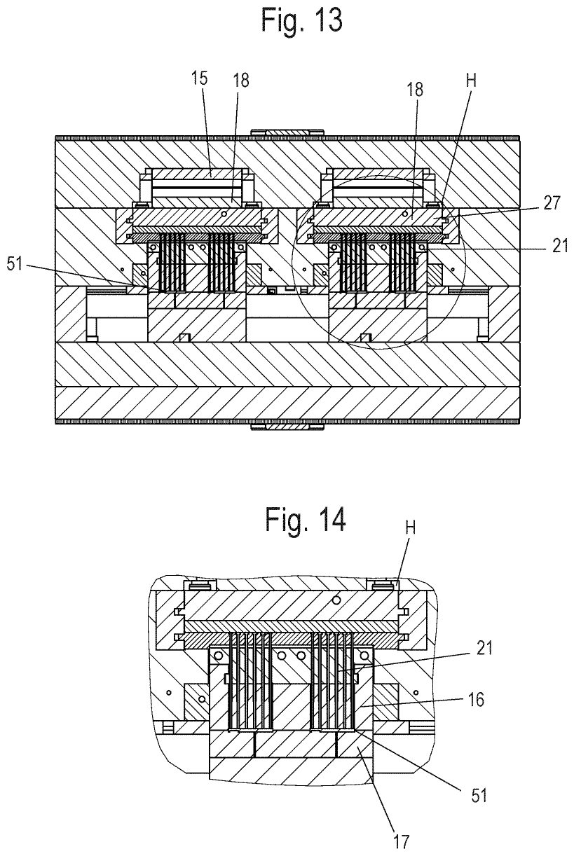

The first process step A is shown in FIGS. 9-14. In a first process step A, a clamping force is built up on the tool, if this has not already been built up in the final process step of the previous cycle, and a cavity 51 is filled between the ejector-side mold insert 16 and the nozzle-side mold insert 17. An injection-molded part is formed and begins to solidify in the cavity 51. A gap is arranged between the ejector retaining plate 12 and the mold insert pressure plate 27, which allows a partial stroke T between the two elements.

A gap between the tool base plate 4 and the mold insert pressure plate 27 allows a stroke H or a total stroke. The toothed rack 18 can be firmly connected to the mold insert pressure plate 27.

The toothed racks 15 and 18 are in a non-toothed position relative to each other. This allows the clamping force to be transmitted or generated by the machine. The position of the projections in the link guide corresponds to position I, i.e., the position in which both mold inserts 16 and 17 are in contact with each other, also known as the injection position.

There are no injection-molded parts 50 in the drop chute 33. The ejector rods 21 are retracted in the tool. The channels 26 can be filled with a temperature-control medium.

Optionally, a main chute and a secondary chute can be provided. The secondary chute is filled by the transport carriages. Several secondary chutes then fill the main chute or open into this main chute, e.g., in the case of large multi-cavity molds.

In the first process step A, injection-molded parts 50′ from the previous process cycle are each simultaneously located in a transport carriage 30. These are in the ejection position Y. Accordingly, the transport carriages are extended into the area of the drop chute 33 due to the rotation of the gearwheel 32 and the transmission of force to the rack and pinion extensions 32.

A pressure surge, e.g., by compressed air, is transmitted via the channel 24 and through the nozzle opening 35 to the injection-molded part in the transport carriage 30. This surge causes the injection-molded part to slide over an inclined plane into the drop chute 33 due to the tilted position.

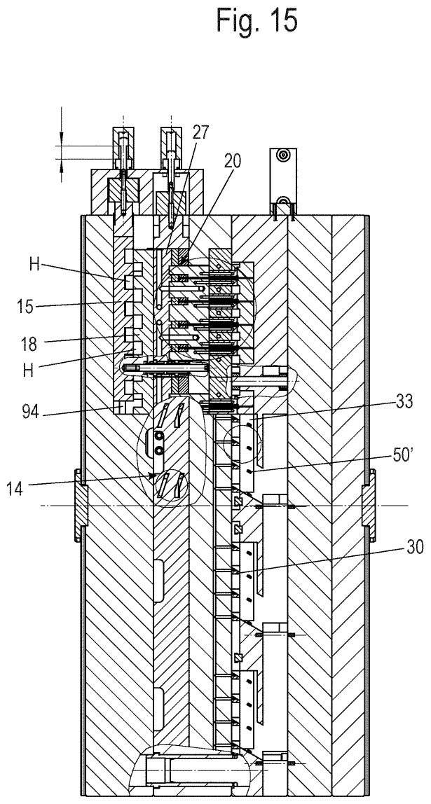

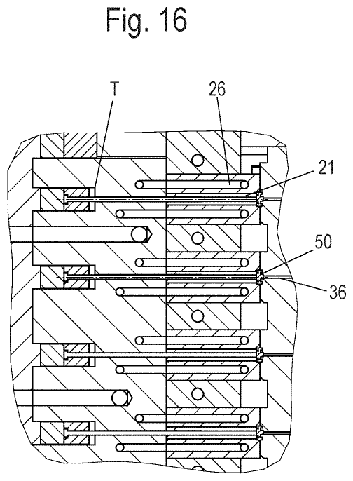

A second process step B is shown in FIGS. 15-19. In the second process step B, the clamping force is initially maintained. A subsequent pressing of melt takes place to compress the injection-molded part. Further cooling of the injection-molded part 50 takes place in particular also by means of the cooling medium continuously conducted in the channels 26. Once the injection-molded part is sufficiently compacted, the clamping force is reduced. After this has been reduced, one of the toothed racks 18 of the locking mechanism, starting from a locking position, begins a movement process relative to the corresponding non-moving toothed rack 15 by a linear travel distance 94 until an unlocking position is reached. A closing force reduction by moving the toothed rack 15 is conceivable. The movement is linear and preferably occurs parallel to the opening plane E of the tool 1. A stroke space H is released.

Preferably at the same time, the injection-molded parts 50′ fall down inside the drop chute 33, from where they can optionally reach a collecting space inside the tool 1 or outside the tool 1.

The prescribed sequence is not mandatory. It is an advantage of the present invention that various process steps can be parallelized. The sequencing and parallelization of individual process steps depends on the speed of the individual steps.

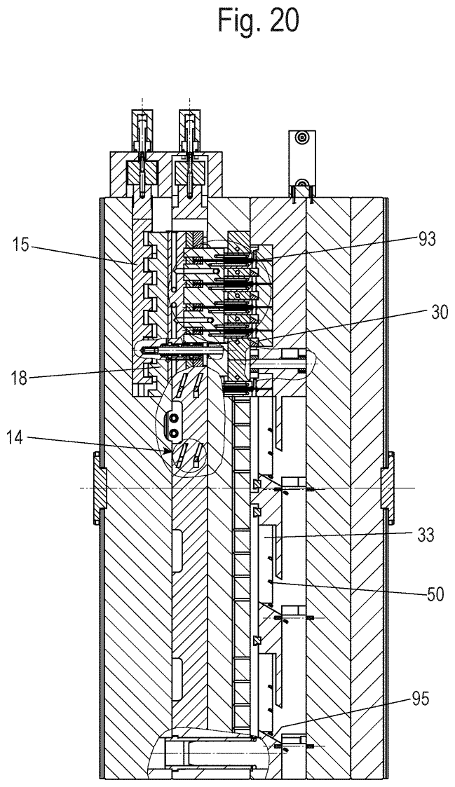

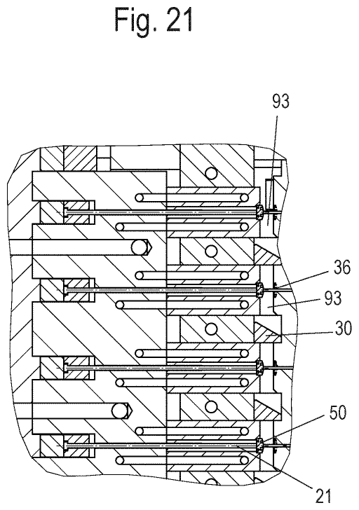

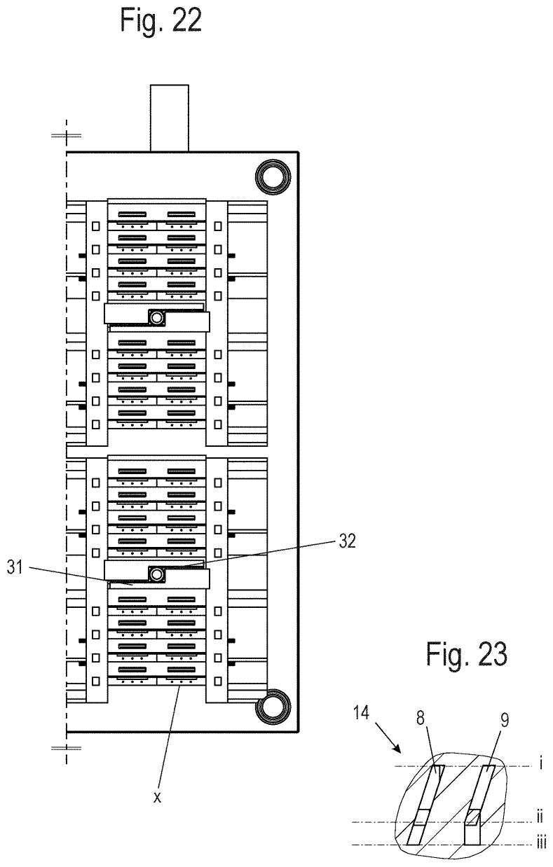

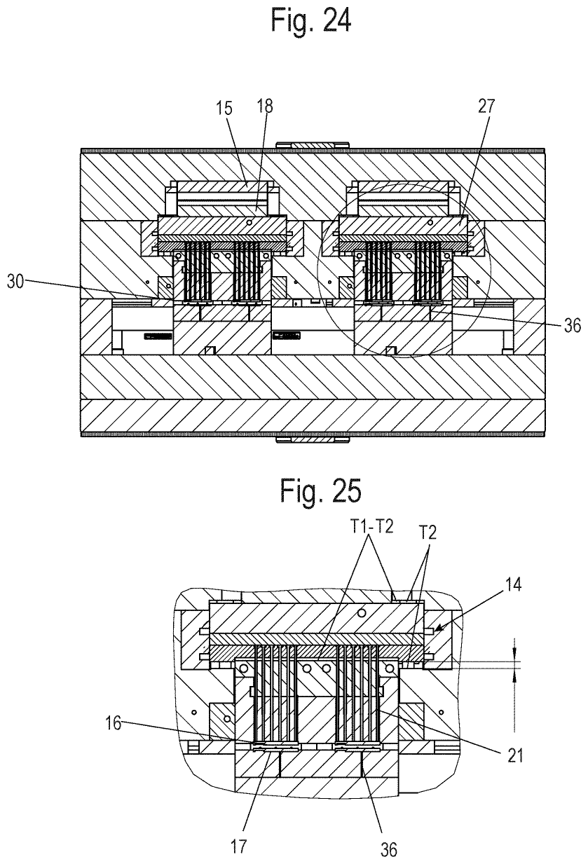

In a third process step C, shown in FIGS. 20-25, the opening of the molding area takes place. In particular, the cavity 51 opens in the circumference of an opening gap 93. The protrusions of the link guide 14 move to a position ii and the mold insert pressure plate 14 has been moved by a partial stroke T. The ejector-side mold insert 16 is moved away from the nozzle-side mold insert 17. The movement is also performed by the ejector package 20 and the mold insert retaining plate 11 and mold insert pressure plate 27, which lower into and are received in the clearance 13 between the bearing strips 7 or in the frame plate 91.

The joint concerted movement of the mold insert 16, the mold insert retaining plate 11, the mold insert pressure plate 27, and the ejector package 20 occurs as part of a guided movement. In this process, individual elements, such as the ejector pressure plate 23 and the mold insert pressure plate 11, may have fixed or integrally formed edge projections 71, which engage in guide slots 8 and 9 of the link guide 70 of the bearing strips 7 fixed in process step C or the frame plate 91 fixed in process step C.

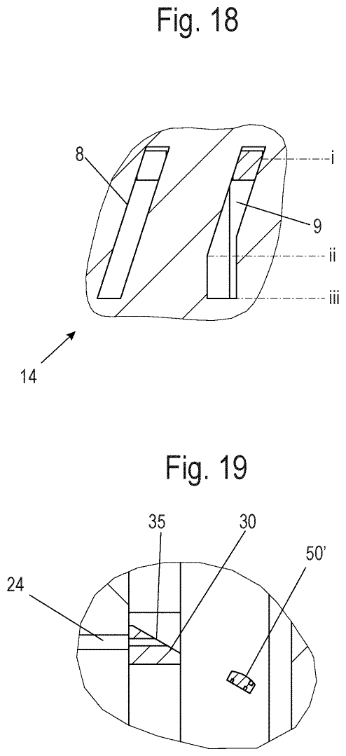

In FIGS. 18, 23 and 29, the link guide 14 is shown in detail. The respective process step can be derived from the position of the projections 71. In position i of the projection in the guide slot, the tool is in the injection position. It is also the end stop and the position of the projection within the guide slot 8 and 9 closest to the nozzle side.

In position ii of the protrusion in guide slot 8 or 9, cavity 51 is open, but the injection-molded part is held against the surface of ejector-side mold insert 16.

In position iii of the protrusion in the guide slot or 9, the cavity 51 is open and the ejector rods are extended and protrude to some extent from the surface of the ejector-side mold insert 16. It is conceivable that, by means of a so-called accelerator system, an ejector rod executes a shorter stroke. As a result, the injection-molded part will lie slightly angled in space with respect to the parting line. The injection-molded part will no longer lie flat against the ejector rods. Adhesion and grip between the ejector rods and the injection-molded part will therefore be greatly reduced. This ensures reliable demolding from the ejector-side elements. It is conceivable that demolding could be checked by additional sensors.

Position ii is reached in the third process step C. During the tool opening process, there is also an extension of the nozzle-side ejector rod 36, which presses the injection-molded part 50 against the surface of the mold insert 16. This serves to position it in the carriage 30.

In the third process step C, the transport carriages 30 are moved linearly from the ejection position Y in the plane of the drop chute 33 to the pick-up position X next to the drop chute 33 and below the respective mold insert 16 by moving the gearwheel 32.

From one section of the drop chute 33, the ejected injection-molded parts 50′ slide along an inclined plane 95 into another section of the drop chute 33.

From FIG. 25, it can be seen that in position ii, the mold inserts 16 can perform a partial stroke T1 and the ejector package 21 can perform a partial stroke T2, with the partial stroke T1 of the mold inserts being greater than the partial stroke T2 of the ejector package.

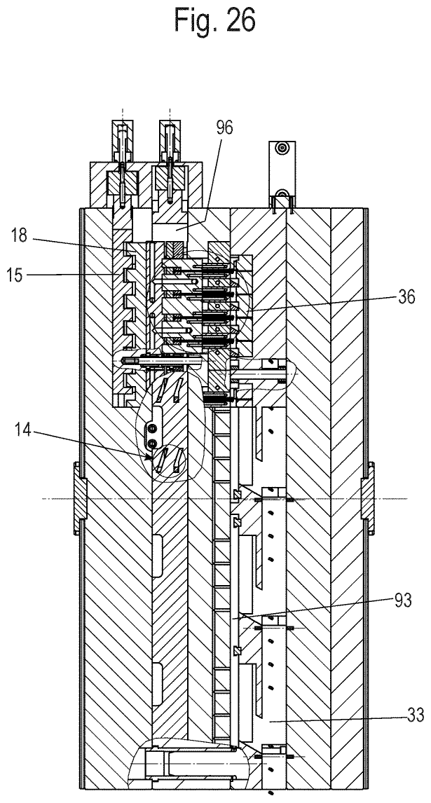

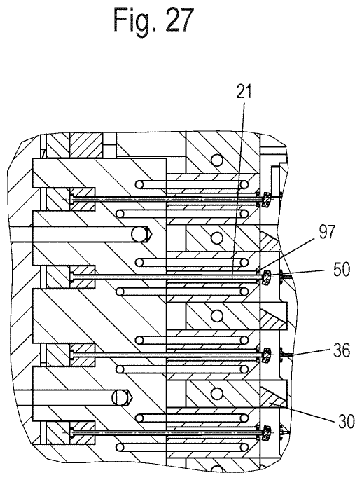

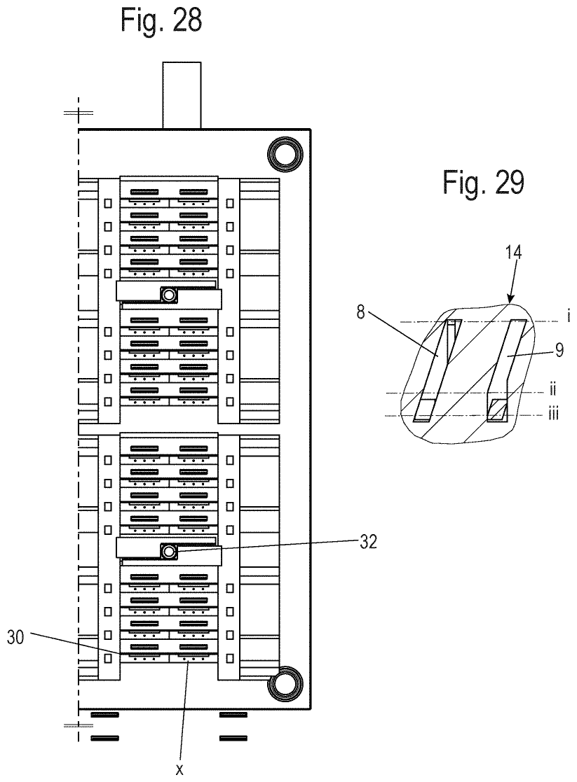

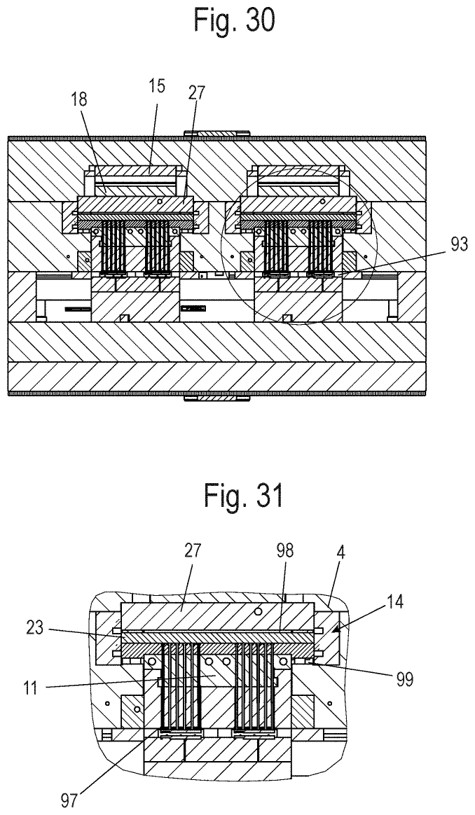

In a fourth process step D, as shown in FIGS. 26-31, a continuous demolding is performed. In this process, due to a different pitch of the guide slots 8 and 9 from position ii to position iii, as previously described, the mold insert 16 is moved more than the ejector package 20, which results in the ejector rods 21 protruding from the surface of the mold insert 16 with an ejector tip 97 due to the greater lowering of the mold insert 16, thereby lifting the injection-molded part from the mold insert 16. At the same time, the ejector rod 36 is retracted into the nozzle-side mold insert 17 so that the injection-molded part is released. The injection-molded part falls down. Meanwhile, the actuating element 19 has moved back to the starting position of FIG. 9. The travel distance 96 of the actuating element allows conclusions to be drawn about the total stroke of the components within the tool. In step D, the opening gap 93 is present, allowing the injection-molded parts 50 to fall into the transport carriages over a very low drop height. The protrusions in the guide slots 8 and 9 of the link guide 14 are at position iii, the demolding position.

From FIG. 31, it can be seen that the ejector package 20 rests on the mold insert retaining plate 11 and that the mold insert pressure plate 27 also rests on the tool base plate 4. The stroke 99 reflects the maximum travel distance of the ejector package 20. However, there is a gap 98 between the mold insert pressure plate 27 and the ejector pressure plate 23, which corresponds to the amount by which the ejector tips 97 protrude from the surface of the mold insert 16.

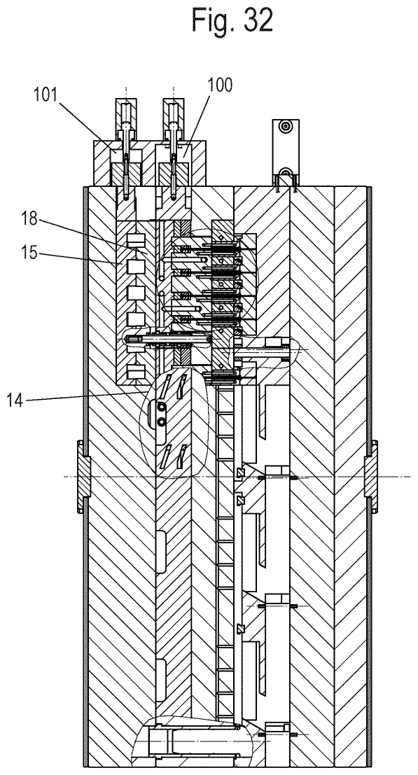

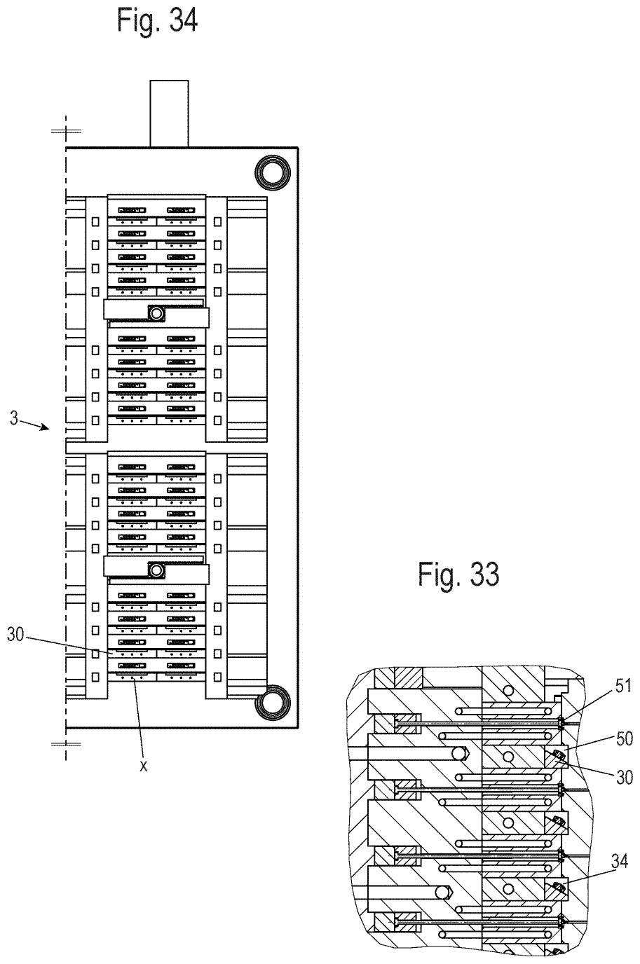

In a fifth process step E, shown in FIGS. 32-34, the mold inserts 16 and 17 and the other components associated with them are moved together to form the cavity 51 and build up a closing force. The closing force is preferably built up by the machine after moving the toothed rack 15. It is also possible to build up the force by moving the toothed rack 15. In this process, the protruding pins are upset in the stacking direction and a specific compressive stress is generated at the contact surfaces. This then produces the closing force. The two toothed racks 15 and 18 each have a travel distance 100 and 101 at their disposal. Cavity 51 is still unfilled, but the injection-molding process is imminent. The carriages 30 are still in the pickup position X, but will soon be moved to the ejection position Y.

At the same time, the injection-molded parts are picked up by the transport carriage 30, which then moves to the ejection position Y and optionally remains there in a tilted position.

The tool 1 is closed while the process steps A-E are running.

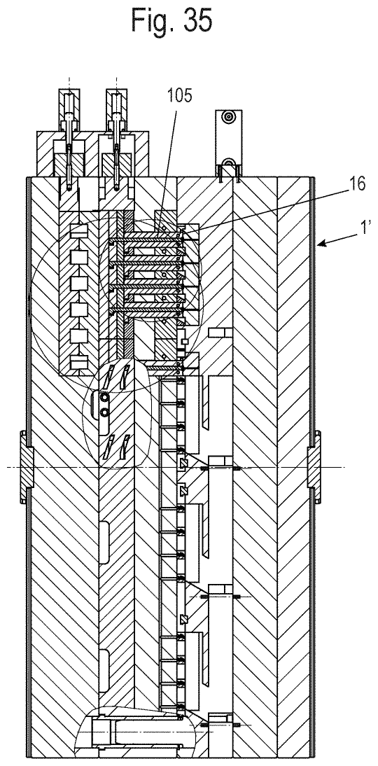

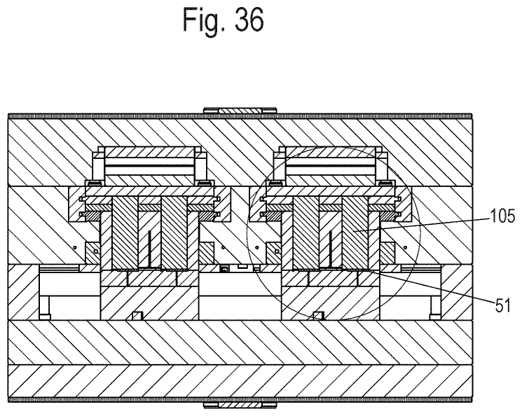

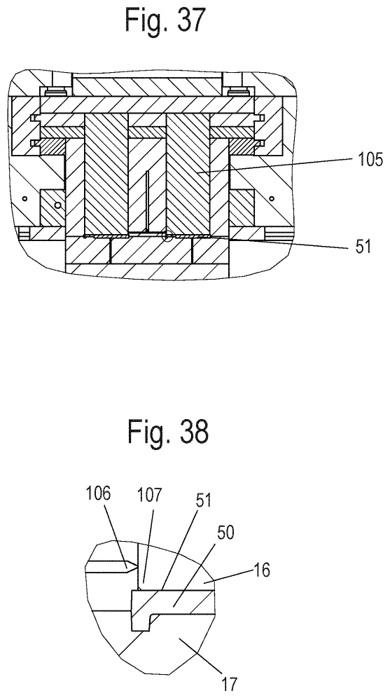

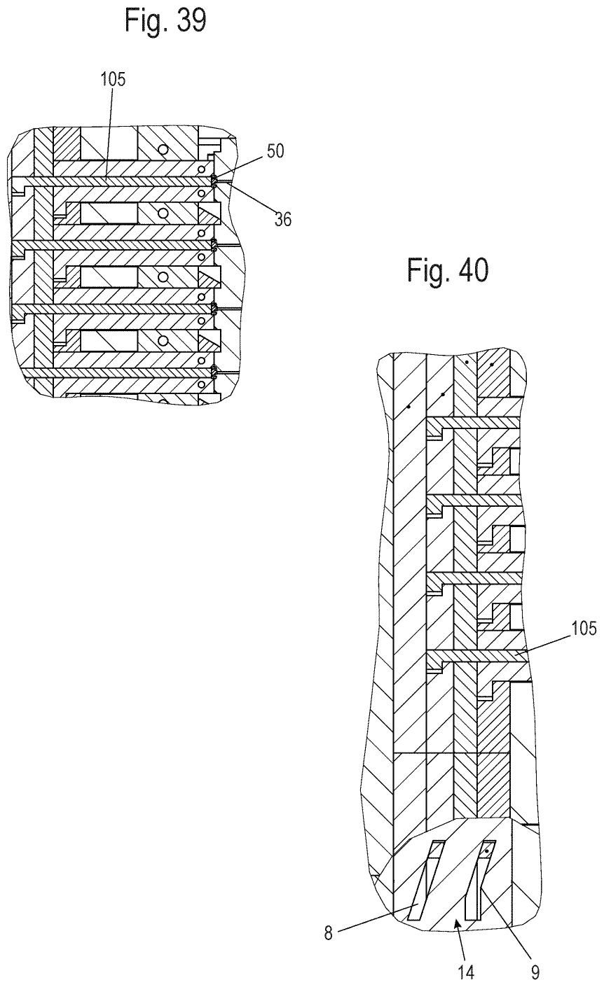

FIGS. 35-40 show a second variant of a tool 1′ according to the invention in modification to the first variant of the preceding figures. Instead of the ejector package 20, a mold core 105 is used in the central area of the mold insert 16.

Compressed air is used to eject the injection-molded part 50 via a compressed air channel or sequence of compressed air channels 104, 106, 107, which opens into the cavity 51 on the inside of the mold insert 16. The other operations (e.g., the movement of the transport carriage or the mold insert 16) of the injection mold remain substantially the same except for the movement of the ejector package.

In particular, the variant of the removal and especially preferably the variant of the transport carriage and the associated advantageous low drop height can also be transferred to other variants of injection molds in which the tool halves and thus the overall frame opens and closes in a conventional manner. The variant of the removal can thus be understood as an independent invention, which, however, in particular in the context of the variant of the moving component(s), brings additional synergetic advantages compared to the static and closed overall frame, in particular due to the combination of the low drop height, low stroke mass and the low opening stroke. Injection-molded parts with finer contours and/or made of easily breakable plastic can be produced in low cycle times.

The tool according to the invention enables a cycle time reduction of at least 0.15 s, preferably even of at least 0.3 sec. In some applications, this can reduce the total cycle time by up to 50% or even far beyond.

Another particular advantage is the parallelization of the movement of the mold insert or mold unit and the ejector unit. This enables an additional reduction in the cycle time.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 Injection-molding tool
2 First tool half (ejector)
3 Second tool half (nozzle)
4 Tool base plate (ejector side)
5 Recess for locking
6 Locking mechanism
7 Bearing strip
8 Guide slot
9 Guide slot
10 Actuating element
11 Mold insert retaining plate
12 Ejector retaining plate
14 Link guide
15 Base plate
16 Mold insert (ejector side)
17 Mold insert (nozzle side)
18 Support plate
19 Actuating element
20 Ejector package
21 Ejector rods
22 Actuating element
23 Ejector pressure plate
24 Channel (frame part)
25 Channel (mold insert pressure plate)
26 Channel (mold insert)
27 Mold insert pressure plate
30 Transport carriage
30a Unit of carriages
30b Unit of carriages
31 Rack and pinion extension
32 Gearwheel
33 Drop chute
34 Receiving space
35 Nozzle opening
36 Nozzle-side ejector rod
40 Guide column
41 Guide bush
42 Frame insert
50 Injection-molded part
51 Cavity
80 Tool base plate (nozzle side)
81 Centering ring
91 Frame part
92 Frame part
93 Opening gap
94 Linear travel distance
95 Inclined plane
96 Travel distance
97 Protruding tip
98 Additional stroke
99 Partial stroke
100 Travel distance
101 Travel distance
1′ Tool
104 Channel
105 Channel
106 Channel
107 Channel
Position i
Position ii
Position iii
Receiving position X
Ejection position Y
Falling direction F
Opening plane E
Stroke H
Partial stroke T

1-25. (canceled)

26. A tool for the injection molding of plastic parts, the tool comprising:
a static overall frame formed by at least two frame units, wherein the at least two frame units include a first ejector-side tool element and a second nozzle-side tool element, which are displaceable relative to one another, but are displaceable in a production mode within the limits of elasticity, which is less than one millimeter; and
two structural units for forming a cavity, wherein a first one of the two structural units is arranged displaceably relative to the overall frame and a second one of the two structural units for removing an injection-molded part from the cavity.

27. The tool of claim 26, wherein adjacent to and below one of the two structural units or the cavity, a removal of the discharged injection-molded parts takes place, and a transport device for the removal is associated with the tool.

28. The tool of claim 26, wherein the tool has a discharge for removing formed injection-molded parts from an area of the two structural units in a closed state of the tool.

29. The tool of claim 27, wherein an opening of the two structural units required for discharge is minimally larger than a minimum dimension of the plastic parts between 0-100% thereof or is not 0-100% larger than a width of the transport device provided for discharge.

30. The tool of claim 26, wherein the at least two frame units are displaceable within the scope of setting movements or due to wear protection less than five millimeters.

31. The tool of claim 26, wherein the discharge for removal of the injection molded parts takes place when the tool is in a closed state.

32. The tool of claim 26, wherein the displaceability of the first one of the two structural unit is ensured in the production mode, which comprises a discharge of the injection-molded part from the cavity.

33. The tool of claim 26, further comprising:
a retaining element that ensures that the injection-molded part is retained on one of the two structural units during displacement of the first one of the two structural units.

34. The tool of claim 26, further comprising:
an ejector unit configured to lift the injection-molded part from one of the two structural units.

35. The tool of claim 28, wherein the two structural units each comprise at least one mold insert, wherein a nozzle-side mold insert and a ejector-side mold insert form the cavity, wherein the at least one mold insert of the two structural units each remain in a respective frame unit during the production mode.

36. The tool of claim 35, wherein the discharge for removing the injection-molded parts is a drop chute.

37. The tool of claim 36, further comprising:
at least one row of the at least one mold insert, wherein the drop chute extends parallel adjacent to the at least one row of the at least one mold insert.

38. The tool of claim 26, further comprising:
a plurality of linearly movable transport carriages configured to transport the injection-molded part, wherein each transport carriage of the plurality of linearly movable transport carriages is configured to partially or completely receive the injection-molded part.

39. The tool of claim 38, wherein each of the plurality of linearly movable transport carriages has a rack and pinion extension arranged relative to a drive gearwheel in such a way that, when the drive gearwheel is moved, at least two transport carriages of the plurality of linearly movable transport carriages are arranged to be linearly movable in opposite directions to one another.

40. The tool of claim 26, wherein the first one of the two structural units consists of a mold unit and an ejecting unit, wherein the mold unit is movable to a greater extent than the ejecting unit.

41. The tool of claim 40, wherein displacement of the ejecting unit and mold unit is performed by a single drive.

42. The tool of claim 40, wherein the first ejector-side mold element has a locking mechanism configured so that unlocking of the locking mechanism causes a linear, lifting movement of the mold unit and the ejecting unit relative to a mold base plate.

43. The tool of claim 42, wherein the locking mechanism comprises a toothing between a first toothed rack, which is displaceably mounted in a direction perpendicular to teeth of the toothing, and a second toothed rack configured to apply pressure to the mold unit.

44. The tool of claim 40, wherein displaceability of at least one of the mold units or of the ejector units is effected by a guided stroke movement of one of the two structural units or of one or more plates acting on one of the two structural units, wherein the tool comprises a link guide configured to guide the stroke movement of a respective mold unit, ejector unit, or the one or more plates.

45. The tool of claim 44, wherein the link guide has at least two guide slots in which projections of a respective mold unit, the ejector unit, or the one or more plates engage, wherein the guide slots have a different pitch at least in some areas.

46. The tool of claim 45, wherein the tool is configured in such a way that a stroke movement of ejector rods of the ejector unit is less than a stroke movement of the mold unit.

47. A method for the injection molding of an injection-molded part in a tool comprising a static overall frame formed by at least two frame units, wherein the at least two frame units include a first ejector-side tool element and a second nozzle-side tool element, which are displaceable relative to one another, but are displaceable in a production mode within the limits of elasticity, which is less than one millimeter, and two structural units for forming a cavity, wherein a first one of the two structural units is arranged displaceably relative to the overall frame and a second one of the two structural units for removing an injection-molded part from the cavity, wherein the method comprises a production mode comprising:
injection molding of an injection-molded part with the cavity closed;
releasing from the cavity and cooling the injection-molded part by carrying out a stroke movement of the one of the two structural units with an ejector-side mold insert relative to a second one of the two structural units with a nozzle-side mold insert, forming an opening gap; and
removing the injection-molded part from the opening gap between two the structural units,
wherein the tool remains closed during execution of the production mode.

48. The method of claim 47, wherein the release of the cavity is performed in a concerted stroke movement of the ejector-side mold unit with an ejector unit, wherein a stroke of the ejector-side mold unit and a stroke of the ejector unit are of different sizes.

49. The method of claim 47, wherein after the injection-molded part is removed from the opening gap, the injection-molded part is transferred to a drop chute by a linearly movable transport carriage, wherein the removal of the injection-molded part occurs at a same time as injection molding and releasing of a subsequent injection molded part of a subsequent pass, and wherein the removal the injection molded part is completed at the end the releasing from the cavity of the subsequent injection molded part of the subsequent pass.

50. The method of claim 47, wherein the removal of a first batch of injection-molded parts from the tool is performed simultaneously with the molding and/or cooling of a second batch of injection-molded parts.
